(19) United States
(12) Patent Application Publication
(10) Pub. No.: US 2005/0160030 A1
(43) Pub. Date: Jul. 21, 2005

(54) Relative pricing for proposals for trading of financial interests

(76) Inventors: James William White, Montvale, NJ (US); Christopher James Hodder, Philadelphia, PA (US); Michael Tobey, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/963,462

(22) Filed: Oct. 12, 2004

Related U.S. Application Data
(60) Provisional application No. 60/510,605, filed on Oct. 10, 2003.

(51) Int. Cl. G06F 17/60

(52) U.S. Cl. 705/37

(57) ABSTRACT

A system, computer program, and method enable a trader to propose a trade in a financial interest where the price proposed for the financial interest is related to a price for the same or different financial interests and where the proposed price is updated at specified time intervals based on the relationship to the price for the same or different financial interests.

### CROSS REFERENCE TO RELATED APPLICATION

This application claims the benefit of U.S. provisional patent application Ser. No. 60/510,605, “RELATIVE PRICING FOR PROPOSALS FOR TRADING OF FINANCIAL INTERESTS,” filed 10 Oct. 2003, the entire contents of which are hereby incorporated in full by this reference.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

This application contains material relating to the trading of financial interests. The trading of some financial interests is regulated, as for example by the United States Government, the various State governments, and other governmental agencies within the United States and elsewhere. The disclosure herein is made solely in terms of logical and financial possibility and advantage, without regard to possible statutory, regulatory, or other legal considerations. Nothing herein is intended as a statement or representation of any kind that any method or process proposed or discussed herein does or does not comply with any statute, law, regulation, or other legal requirement whatsoever, in any jurisdiction; nor should it be taken or construed as doing so.

### BACKGROUND OF THE INVENTION

The invention relates to trading of financial interests, and in particular to programs, methods, and systems for relative pricing of proposed trades of financial interests.

### SUMMARY OF THE INVENTION

The system and method of the present invention enable a trader to propose a trade in a financial interest where the price proposed for the financial interest is related to a price for the same or different financial interests and where the trader specifies a time interval at which the proposed price is to be updated based on the relationship to the price for the same or different financial interests.

An embodiment of the invention provides a method for facilitating the trading of financial interests. First, terms for a proposed trade are received, the terms including at least an identification of a first financial interest to be traded, a description of a reference price, a description of a relationship between a price for the proposed trade and the reference price, and a description of a time interval. Next, the reference price is determined at a subsequent expiration of the described time interval based on the description of the reference price. Then, the proposed price for the trade is determined at the subsequent expiration of the described time interval based on the determined reference price and the described relationship.

According to an embodiment of the invention, the description of the reference price describes a price of the first financial interest.

In another embodiment of the invention, the description of the reference price describes a price related to one or more financial interests other than the first financial interest.

According to another embodiment of the invention, the description of the reference includes a description of a plurality of prices and one or more conditions such that the reference price description describes at least one of the plurality of prices if at least one of the one or more conditions is met and the reference price description describes at least one other of the plurality of prices if the at least one of the one or more conditions is not met.

According to another embodiment of the invention, the description of a time interval describes a periodic time interval.

In a different embodiment of the invention, the description of a time interval describes a random time interval.

Another embodiment of the invention provides a system for facilitating the trading of financial interests. The system includes a memory and a computer. The memory stores terms for a proposed trade, the terms including at least an identification of a first financial interest to be traded, a description of a reference price, a description of a relationship between a price for the proposed trade and the reference price, and a description of a time interval. The computer is programmed to determine, at a subsequent expiration of the described time interval, the reference price based on the description of the reference price, and the proposed price for the trade based on the determined reference price and the described relationship.

Another embodiment of the invention provides a computer program product comprising a computer usable medium having computer readable code embodied therein, the computer readable code, when executed, causing a computer to implement a method for facilitating the trading of financial interests. According to the executed method, first, terms for a proposed trade are received, the terms including at least an identification of a first financial interest to be traded, a description of a reference price, a description of a relationship between a price for the proposed trade and the reference price, and a description of a time interval. Next, the reference price is determined at a subsequent expiration of the described time interval based on the description of the reference price. Then, the proposed price for the trade is determined at the subsequent expiration of the described time interval based on the determined reference price and the described relationship.

According to another embodiment of the invention, a method is provided for setting a price term of a financial interest offered or bid in a computerized trading system. First, a time interval is initialized. Next, a determination is made as to whether the time interval has expired. If the time interval has expired, a reference price is obtained and the price term is set based on the reference price.

In an embodiment of the invention, the time interval initialized has a random length.

According to another embodiment of the invention, a method is provided for facilitating the trading of financial interests. According to the method, at least one computer determines whether a time interval described by a trading party and associated with a proposed trade of a financial interest proposed by the trading party has expired. Then, if the time interval has expired, the at least one computer changes at least one term associated with the proposed trade.

In another embodiment of the invention, the at least one term that is changed includes a quantity.

According to another embodiment, the at least one term that is changed includes a first quantity provided by the trading party and a second quantity representing a quantity for the proposed trade that is executable in a market. Upon the expiration of the time interval, the at least one computer changes the second quantity to match the first quantity.

In another embodiment of the invention, the at least one term that is changed includes a price for the proposed trade.

In this embodiment, the at least one computer may change the price for the proposed trade based on a description of a reference price and a description of a relationship between the reference price and the price for the proposed trade.

Additional aspects of the present invention will be apparent in view of the description which follows.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a block diagram of an embodiment of the system of the present invention showing the environment in which the system operates.

FIG. 2 is a flowchart showing an operative embodiment of the present invention;

FIG. 3 is a flowchart showing another operative embodiment of the present invention; and

FIG. 4 is a flowchart showing another operative embodiment of the present invention.

### DETAILED DESCRIPTION

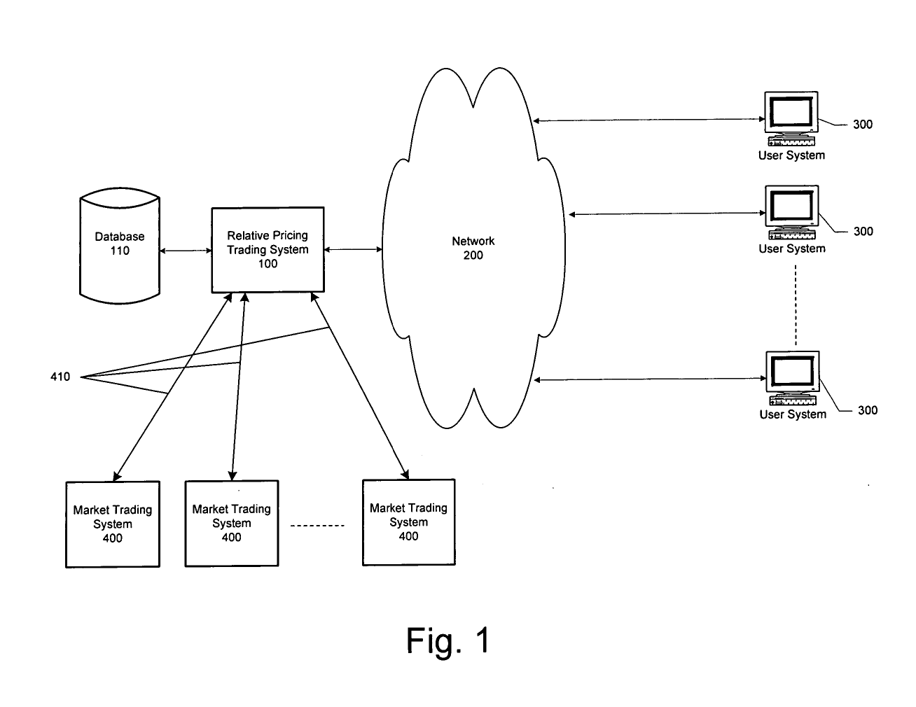

FIG. 1 is a block diagram showing an embodiment of the Relative Pricing Trading (“RPT”) System of the present invention and the environment in which it operates. As shown in FIG. 1, the Relative Pricing Trading (“RPT”) System 100 of the present invention communicates with one or more users at User Systems 300 through Network 200. RPT System 100 also is in communication with one or more Market Trading Systems 400 and Database 110.

Network 200 may comprise any communications network or other means through which computer systems may communicate with each other, such as a proprietary electronic communications network (“ECN”) or a public network such as the Internet. Also, although Network 200 is shown in FIG. 1 as a single network, it should be understood that First Network 200 may comprise a plurality of networks in communication with each other.

User Systems 300 enable users to interact with RPT System 100 through Network 200. Users may include traders of financial interests or agents working on behalf of traders. Financial interests may include any item that may be traded in a market, such as, for example, equity securities, e.g., stocks, fixed income securities, e.g., bonds, commodities, energy contracts, and foreign currencies. User Systems 300 may comprise any computer systems that enable users to enter and send data to and receive and view data from RPT System 100 via Network 200, such as, for example, personal computers equipped with software that provides a graphical user interface (“GUI”) through which trading data is presented to and received from the user.

Market Trading Systems 400 represent computer systems operated by markets in which financial interests are traded, e.g., the New York Stock Exchange (“NYSE”) and the National Association of Securities Dealers Automatic Quotation System (“NASDAQ”). Market Trading Systems 400 may include systems operated in contractual or other legal privity, or not. Communication links 410 between the Market Trading Systems 400 and RPT System 100 enable RPT System 100 to send to and receive from Market Trading Systems 400 data related to financial interests and proposed trades involving financial interests traded in the respective markets of the Market Trading Systems 400. Communication links 410 may include any means through which computer systems may exchange data, including means such as those described above for Network 200.

RPT System 100 enables users at User Systems 300 to trade financial interests in the markets corresponding to Market Trading Systems 400. In an embodiment of the present invention, RPT System 100 may comprise any computer system that (a) enables a user to enter a proposed trade for a financial interest into a market for the financial interest, where the price of the proposed trade is specified in relation to a reference price, and (b) updates the price of the proposed trade based on the reference price at specified time intervals. For example, RPT System 100 may comprise a computerized trading system, such as the TRADEBOOK® system available over the BLOOMBERG PROFESSIONAL® Service, that provides the functionality described below.

The reference price may be a price of the same financial interest that is the subject of the proposed trade or it may be a price related to one or more other financial interests, such as, for example, a composite price representing all of the one or more other financial interests. Also, the reference price may be of any known price type, e.g., bid, ask, mid, or last trade. For example, the reference price may be specified as the current best bid price for the financial interest that is the subject of the proposed trade. Also, the reference price may be specified as different prices depending on various conditions, as described further below.

The relationship between the price of the proposed trade and the reference price may include any means for determining the price of the proposed trade based on the reference price. For example, the relationship may include a mathematical relationship such as the addition or subtraction of an offset so that the price of the proposed trade is determined as the reference price plus or minus the offset. In another example, the mathematical relationship may include a factor by which the reference price is to be multiplied to determine the price of the proposed trade.

The relationship may also include a limit such that, for example, when the price of the proposed trade is updated, that price cannot exceed (for a proposed buy) or fall below (for a proposed sell) the specified limit.

The time interval at which the price of the proposed trade is updated (“the update interval”) may be specified in a number of ways. For example, the update interval may be specified as a periodic time interval, e.g., 20 seconds, such that, at the end of each successive occurrence of the periodic time interval, the price of the proposed trade is updated if necessary, as described below. If desired, minimum and maximum limits for the time interval may be set such that the specified time interval must fall within these limits. Also, a minimum increment may be set such that the specified time interval may be allowed to vary only by multiples of the minimum increment. For example, if the minimum increment is 5 seconds, then the update time interval must be specified in increments of at least 5 seconds, e.g., 5 seconds, 10 seconds, or 40 seconds.

In addition to specifying the update interval as a periodic time interval, the update time interval may be specified as a random time interval, e.g., a time interval of random length that is greater than a specified minimum and less than a specified maximum. For example, where the specified minimum and maximum limits for the random interval (which may be different than the minimum and maximum limits mentioned above) are 5 seconds and 120 seconds, respectively, and the minimum increment is set to 5 seconds, then each successive update interval will be a random multiple of 5 seconds in length between a minimum of 5 seconds and a maximum of 120 seconds.

For instance, the first update interval after the proposed trade is initially entered is randomly determined to be 20 seconds. After 20 seconds has elapsed, this first update interval expires and the price of the proposed trade is updated if necessary. The next update interval is randomly determined to be 100 seconds, so that the next price update, if necessary, will occur after 100 seconds have elapsed.

Referring again to FIG. 1, RPT System 100 is also in communication with Database 110 such that RPT System 100 can store data in and retrieve data from Database 110. For example, Database 110 may reside in the same computer system as RPT System 100 or Database 110 may reside in a separate computer system that has communication links with RPT System 100. Database 110 stores all the proposed trades entered by the users associated RPT System 100.

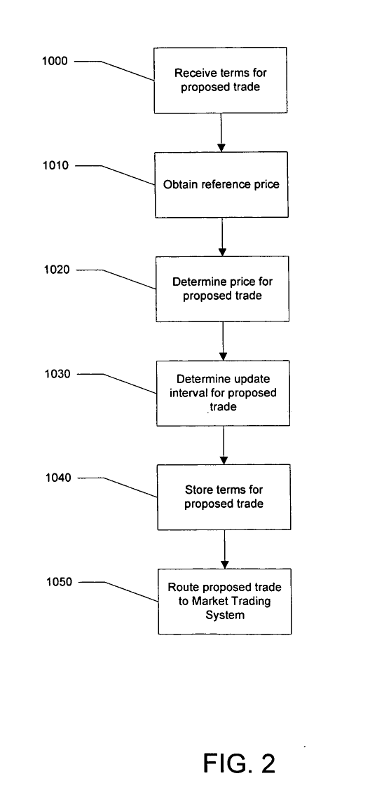

FIG. 2 is a flowchart showing one way in which the present invention may operate. FIG. 2 relates to the operations involved in initially entering a proposed trade. First, as represented in block 1000, terms for a proposed trade are received at RPT System 100. For example, RPT System 100 may present to a user at a User System 300 a GUI that enables the user to enter such terms as, for example, an identity of the financial interest to be traded, a quantity to be traded, a description of a reference price, a description of a relationship between the price of the proposed trade and the reference price (e.g., an offset to be added or subtracted or a factor to be multiplied, as described above), a limit, and a description of an update interval (e.g., a periodic interval or a “random” designation and minimum and maximum limits for the random interval, as described above).

As mentioned above, the reference price may be a price of the same financial interest that is the subject of the proposed trade or it may be a price related to the prices of one or more other financial interests. If desired, the reference price may default to a price of the same financial interest that is the subject of the proposed trade unless specified otherwise by the user. If the description of the reference price provided by the user specifies that the reference price is related to the prices of one or more other financial interests, the GUI may allow the user to identify the one or more other financial interests whose prices will be used to determine the reference price. Also, if the reference price is related to the prices of a plurality of other financial instruments, the GUI may allow the user to provide, as part of the description of the reference price, guidelines for determining how the reference price is related to the prices of the plurality of other financial instruments (e.g., a formula). Also, the user may specify the type of price to which the reference price refers (e.g., bid, ask, mid, or last trade) as part of the description of the reference price. In addition, the user may describe the reference price as different prices depending on various conditions.

If desired, RPT System 100 may also enable a user to provide terms related to the replenishment of the quantity of a proposed trade. For example, RPT System 100 may allow the user to specify the quantity to be traded (or “quantity”) for a proposed trade as a total quantity and a quantity to be displayed (“Displayed Quantity”), where the Displayed Quantity is the maximum quantity of the proposed trade sent to the market at any time. When the quantity of the proposed trade is reduced, e.g., by trades executed in the market, the quantity of the proposed trade may be replenished at certain times to the level of the Displayed Quantity from the total quantity until the total quantity is exhausted.

Once the user has completed inputting the terms for the proposed trade, the input is transmitted over Network 200 and received by RPT System 100. If desired, RPT System 100 may supply default terms where the user has notspecified them. For example, if the user specifies an update interval of “random”, but does not specify minimum and maximum limits, RPT System 100 may supply default minimum and maximum limits.

Next, the reference price for the proposed trade is obtained, as represented in block 1010. As mentioned above, the reference price may be a price of the same financial instrument that is the subject of the proposed trade or may be a price related to one or more other financial interests. To accomplish the operations represented in block 1010, RPT System 100 may, for example, obtain the specified type of price (e.g., bid, ask, mid, or last) for each financial interest related to the reference price from the Market Trading System(s) 400 corresponding to each of the markets in which the respective financial interests are traded. If the reference price is related to the prices of more than one other financial interest, RPT System 100 may determine the reference price based on these prices according to guidelines provided by the user.

Then, as represented in block 1020, a price for the proposed trade is determined. For example, RPT System 100 may determine the price for the proposed trade using the obtained reference price and the relationship between the price for the proposed trade and the reference price that was specified by the user. If the determined price breaches the specified limit, then RPT System 100 sets the price for the proposed trade to the specified limit.

Next, the update interval for the proposed trade is determined, as represented in block 1030. Where the update interval specified by the user is a periodic time interval, then RPT System 100 sets a timer to expire at the end of the duration of the periodic time interval. Where the update interval is specified as a random time interval, RPT System 100 computes a random time interval based on the minimum increment and that falls between the specified minimum and maximum limits for the random interval. RPT System 100 then sets a timer to expire at the end of the duration of the computed random time interval.

The terms for the proposed trade, including the determined price and update interval, are then stored in Database 110, as represented in block 1040. Also, RPT System 100 provides data related to the proposed trade to the Market Trading System 400 corresponding to the market in which the financial interest of the proposed trade will be traded, as represented in block 1050.

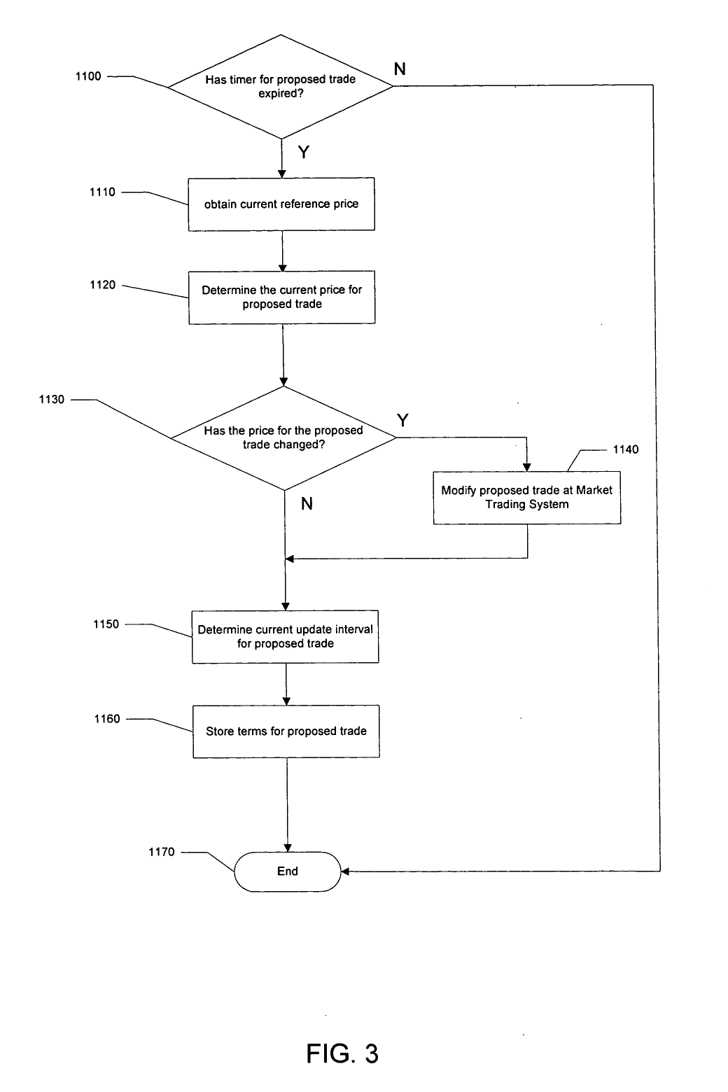

FIG. 3 is a flowchart showing another way in which the present invention may operate. FIG. 3 relates to the updating of proposed trades that have already been entered. After a proposed trade has been entered, and for as long as the proposed trade has not yet been executed, RPT System 100 periodically checks whether the timer for that proposed trade has expired, as represented in block 1100, signifying that the update interval for that proposed trade has ended. If the determination at block 1100 indicates that the timer has not expired, then processing ends at block 1170. RPT System 100 then returns to block 1100 and periodically checking whether the timer has expired.

If the determination at block 1100 indicates that the timer has expired, then processing continues with the operations in block 1110 where the current reference price is obtained. Similar to above, the operations in block 1110 may be accomplished by RPT System 100 obtaining the current value of the specified type of price for each financial interest related to the reference price from the Market Trading System(s) 400 corresponding to each of the markets in which the respective financial interests are traded. If the reference price is related to the prices of more than one other financial interest, RPT System 100 may determine the current reference price based on the current prices of these other financial interests according to guidelines provided by the user.

Next, the current price for the proposed trade is determined, as represented in block 1120. Similar to above, RPT System 100 may determine the current price for the proposed trade using the current reference price and the description stored in Database 110 for this proposed trade of the relationship between the price for the proposed trade and the reference price. If the determined current price for the proposed trade breaches the specified limit stored in Database 110 for this proposed trade, then RPT System 100 sets the current price for the proposed trade to the stored specified limit.

Next, a determination is made as to whether the price for the proposed trade has changed, as represented in block 1130. For example, RPT System 100 may compare the current price for the proposed trade determined by the operations represented in block 1120 with the price for the proposed trade stored in Database 110.

If the determination performed by the operations represented in block 1130 is negative, indicating that the price for the proposed trade has not changed, then processing continues with the operations represented in block 1150 where the current update interval for the proposed trade is determined. Similar to above, if the description of the update interval for this proposed trade stored at Database 110 is a periodic time interval, then RPT System 100 sets a timer to expire at the end of the duration of the periodic time interval. Where the description of the update interval stored for the proposed trade at Database 110 indicates a random time interval, RPT System 100 computes a random time interval based on the minimum increment stored at Database 110 for this proposed trade and that falls between the specified minimum and maximum limits for the random interval stored at Database 110 for this proposed trade. RPT System 100 then sets a timer to expire at the end of the duration of the computed random time interval.

Following the operations represented in block 1150, processing continues with the operations represented in block 1160 where the current value of the terms for the proposed trade are stored in Database 110. For example, the current price for the proposed trade and the current update interval are stored in Database 110.

If the determination performed by the operations represented in block 1130 is positive, indicating that the price for the proposed trade has changed, then processing continues with the operations represented in block 1140 where the proposed trade is modified at the Market Trading System 400 corresponding to the market in which the financial interest of the proposed trade is being traded. To accomplish this, RPT System 100 may instruct this Market Trading System 400 to either modify the existing proposed trade or replace the existing proposed trade with a new proposed trade to reflect the changed price. Processing then continues with the operations represented in block 1150, as described above.

In another embodiment of the invention, the updating of a proposed trade may include replenishing the quantity of the proposed trade, e.g., in accordance with the total quantity and Displayed Quantity terms previously provided by the user, as mentioned above. According to this embodiment, replenishment may be performed at various times and under various conditions. For example, replenishment may be performed only upon the expiration of the time interval specified by the user for the proposed trade. In another example, replenishment may be conditioned upon the occurrence of a price change for the proposed trade.

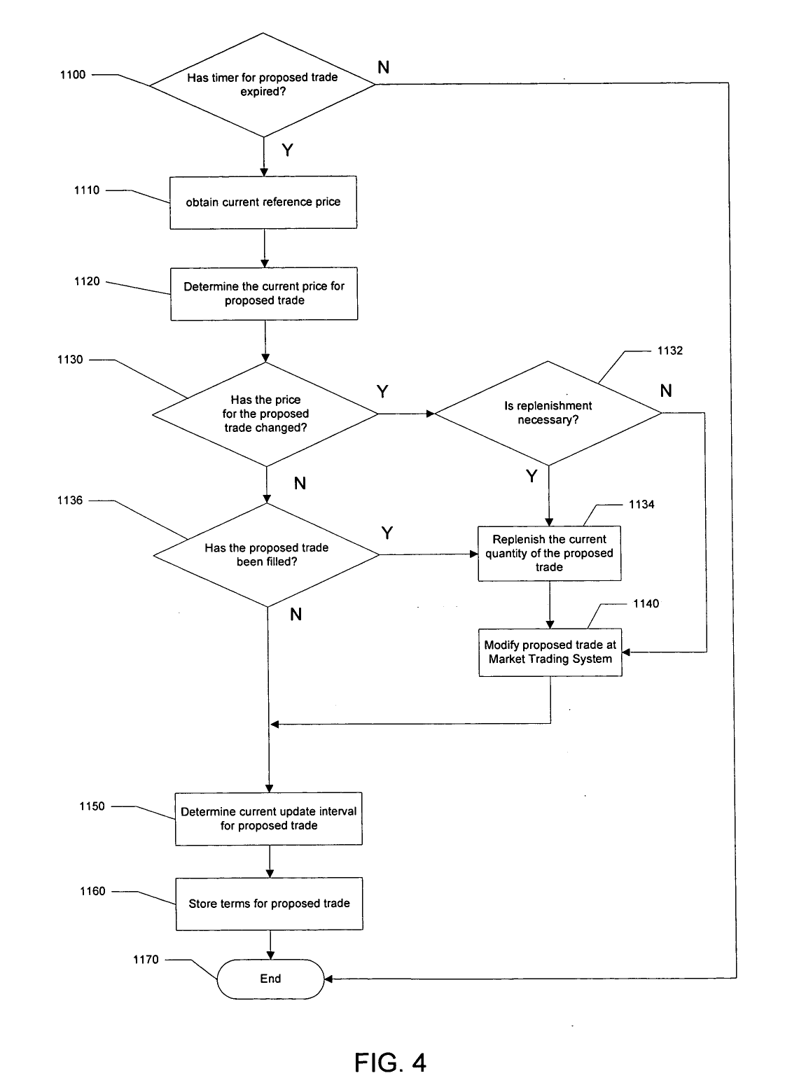

FIG. 4 is a flowchart showing one method of operation for this embodiment where the updating of proposed trades includes replenishment. The operations for blocks shown in FIG. 4 numbered the same as blocks shown in FIG. 3 may be performed the same as the operations for the same numbered blocks of FIG. 3 described above.

As described previously, after the timer expires (block 1100) and the current reference price is obtained (1110), the current price for the proposed trade is determined (block 1120) and a further determination is made as to whether the price for the proposed trade has changed (block 1130). If this determination is positive, then processing continues with the operations of block 1132 where another determination is made as to whether replenishment is necessary. For example, RPT System 100 may determine that replenishment is necessary where the current quantity of the proposed trade (e.g., as obtained by RPT System 100 from the Market System 400 corresponding to the market in which the financial interest of the proposed trade is being traded) has been reduced to less than the Displayed Quantity, e.g., by trades executed against the proposed trade.

If the determination at block 1132 is negative, then processing continues with the operations of block 1140 discussed below. If the determination at block 1132 is positive, then processing continues with the operations of block 1134 where the current quantity of the proposed trade is replenished. This may be accomplished, for example, by RPT System 100 determining the quantity needed to be added (the “Replenish Quantity”) to the current quantity of the proposed trade to make the latter equal to the Displayed Quantity, and if the Replenish Quantity is less than or equal to the current total quantity for the proposed trade (e.g., as previously stored at and retrieved from Database 110 by RPT System 100), then RPT System 100 may add the Replenish Quantity to the current quantity of the proposed trade and subtract the Replenish Quantity from the current total quantity of the proposed trade. If the Replenish Quantity is greater than the current total quantity for the proposed trade, then RPT System 100 may add the current total quantity of the proposed trade to the current quantity of the proposed trade, and reduce the current total quantity of the proposed trade to zero. Following the operations of block 1134, processing continues with the operations of block 1140 discussed below.

If the determination of block 1130 is negative, indicating no change in the current price of the proposed trade, then processing continues with the operations of block 1136 where a determination is made as to whether the proposed trade has been filled, e.g., whether the current quantity of the proposed trade has been reduced to zero. If this determination is positive, then processing continues with the operations of block 1134 as discussed above. Otherwise, processing continues with the operations of block 1150 discussed below.

In the operations of block 1140, as described previously, the proposed trade is modified at the Market Trading System 400 corresponding to the market in which the financial interest of the proposed trade is being traded, e.g., by RPT System 100 instructing this Market Trading System 400 to either modify the existing proposed trade or replace the existing proposed trade with a new proposed trade to reflect the change in price or change in quantity or both.

Following the operations of block 1140 or block 1136, processing continues with the operations of blocks 1150 and 1160 where, as described previously, the current update interval for the proposed trade is determined (block 1150) and current values of the terms for the proposed trade (e.g., current price, current update interval, and current total quantity) are stored in Database 110.

The following example illustrates the operation of the embodiment of FIG. 4 as well as a conditional reference price, e.g., a reference price described by a user as being different prices depending on various conditions.

In the example, a user provides to RPT System 100 the terms of a proposed trade to sell (an offer) a financial interest, where the a total quantity to be traded is 10,000, the Displayed Quantity is 1,000, the price of the proposed trade, in relation to the reference price, is described as the reference price plus one, and the reference price is described as follows: the reference price is the price of the best offer of the same financial interest that is the subject of the proposed trade unless the current price of the proposed trade is the same as the price of the best offer and the current quantity of the proposed trade equals the total quantity available at the price of the best offer, in which case the reference price is the price of the next best offer for the financial interest that is the subject of the proposed trade.

The current conditions of the market in which the financial interest of the proposed trade will be traded are as follows:

| Offer depth including user's proposed | Offer depth without the user's |
|---|---|
| trade | proposed trade |
| 500 offered at 10 | 500 offered at 10 |
| 500 offered at 11 | 500 offered at 11 |

Based on the above market conditions, RPT System 100 obtains the reference price (which in this case is 10—the price of the best offer) from the Market Trading System 400 corresponding to this market (the “Corresponding MTS 400”). RPT System 100 then provides data related to user's proposed trade to the Corresponding MTS 400, including a price for the proposed trade of 11 (the reference price plus one) and a quantity of 1,000 (the Displayed Quantity). After the Corresponding MTS 400 enters the user's proposed trade into the market, the market becomes as follows:

| Offer depth including user's proposed | Offer depth without the user's |
|---|---|
| trade | proposed trade |
| 500 offered at 10 | 500 offered at 10 |
| 1,500 offered at 11 | 500 offered at 11 |
| (user's quantity is 1,000) | |

The 500 offered at 10 and 500 offered at 11 (not the user's quantity) are executed such that at the expiration of the time interval specified by the user for the proposed trade (the “Time Interval”), the market is as follows:

| Offer depth including user's proposed | Offer depth without the user's |
|---|---|
| trade | proposed trade |
| 1,000 offered at 11 | 500 offered at 12 |
| (user's quantity is 1,000) | |
| 500 offered at 12 | |

Since the specified condition is met (the current price of the proposed trade is the same as the price of the best offer and the current quantity of the proposed trade equals the total quantity available at the price of the best offer), RPT System 100 obtains a reference price of 12 (the price of the next best offer) and determines the current price for the proposed trade to be 13 (the reference price plus one). Although the price of the proposed trade has changed, RPT System 100 determines that no replenishment is necessary since the current quantity of the proposed trade is not less than the Displayed Quantity. RPT System 100 then causes the proposed trade to be updated at the Corresponding MTS 400, after which, the market conditions become as follows:

| Offer depth including user's proposed | Offer depth without the user's |
|---|---|
| trade | proposed trade |
| 500 offered at 12 | 500 offered at 12 |
| 1,000 offered at 13 | |
| (user's quantity is 1,000) | |

The 500 offered at 12 and 400 of the user's quantity offered at 13 are executed such that at the expiration of the next Time Interval, the market is as follows:

| Offer depth including user's proposed | Offer depth without the user's |
|---|---|
| trade | proposed trade |
| 600 offered at 13 | 500 offered at 14 |
| (user's quantity is 600) | |
| 500 offered at 14 | |

Since the specified condition is met (the current price of the proposed trade is the same as the price of the best offer and the current quantity of the proposed trade equals the total quantity available at the price of the best offer), RPT System 100 obtains a reference price of 14 (the price of the next best offer) and determines the current price for the proposed trade to be 15 (the reference price plus one). Here, the current price for the proposed trade has changed and RPT System 100 determines that replenishment is necessary since the current quantity of the proposed trade (600) is less than the Displayed Quantity (1,000). Consequently, RPT System 100 adds 400 to the current quantity of the proposed trade and subtracts 400 from the total quantity of the proposed trade which then becomes 9,600. RPT System 100 then causes the proposed trade to be updated at the Corresponding MTS 400, after which, the market conditions become as follows:

| Offer depth inciuding user's proposed | Offer depth without the user's |
|---|---|
| trade | proposed trade |
| 500 offered at 14 | 500 offered at 14 |
| 1,000 offered at 15 | |
| (user's quantity is 1,000) | |

The 500 offered at 14 and 400 of the user's quantity offered at 15 are executed and a new proposed trade from another trading party of 1,700 offered at 15is received such that at the expiration of the next Time Interval, the market is as follows:

| Offer depth including user's proposed | Offer depth without the user's |
|---|---|
| trade | proposed trade |
| 2,300 offered at 15 | 1,700 offered at 15 |
| (user's quantity is 600) | |

Since the specified condition is not met (although the current price of the proposed trade is the same as the price of the best offer, the current quantity of the proposed trade is less than the total quantity available at the price of the best offer), RPT System 100 obtains a reference price of 15 (the price of the best offer) and determines the current price for the proposed trade to be 16 (the reference price plus one). Here, the current price for the proposed trade has changed and RPT System 100 determines that replenishment is necessary since the current quantity of the proposed trade (600) is less than the Displayed Quantity (1,000). Consequently, RPT System 100 adds 400 to the current quantity of the proposed trade and subtracts 400 from the total quantity of the proposed trade which then becomes 9,200. RPT System 100 then causes the proposed trade to be updated at the Corresponding MTS 400, after which, the market conditions become as follows:

| Offer depth including user's proposed | Offer depth without the user's |
|---|---|
| trade | proposed trade |
| 1,700 offered at 15 | 1,700 offered at 15 |
| 1,000 offered at 16 | |
| (user's quantity is 1,000) | |

The 1,700 offered at 15 and 1,000 of the user's quantity offered at 16 are executed and a new proposed trade from another trading party of 500 offered at 15 is received such that at the expiration of the next Time Interval, the market is as follows:

| Offer depth including user's proposed | Offer depth without the user's |
|---|---|
| trade | proposed trade |
| 500 offered at 15 | 500 offered at 15 |
| (user's quantity is 0) | |

Since the specified condition is not met (the current price of the proposed trade, 16, is not the same as the price of the best offer, 15), RPT System 100 obtains a reference price of 15 (the price of the best offer) and determines the current price for the proposed trade to be 16 (the reference price plus one). Although the current price for the proposed trade has not changed, RPT System 100 determines that replenishment is necessary since the current quantity of the proposed trade has been filled, e.g., reduced to zero. Consequently, RPT System 100 adds 1,000 to the current quantity of the proposed trade and subtracts 1,000 from the total quantity of the proposed trade which then becomes 8,200. RPT System 100 then causes the proposed trade to be updated at the Corresponding MTS 400, after which, the market conditions become as follows:

| Offer depth including user's proposed | Offer depth without the user's |
|---|---|
| trade | proposed trade |
| 500 offered at 15 | 500 offered at 15 |
| 1,000 offered at 16 | |
| (user's quantity is 1,000) | |

The present invention described above provides benefits to traders including, among others, the ability to effectively conceal that a trader is moving his or her trades along with the market since the trader's price for his or her proposed trade changes in relation to the reference price after a delayed period. This concealing effect is even greater where the delayed period is randomized.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect or import of the methods described.

1. A method for facilitating the trading of financial interests, comprising:
at least one computer determining whether a time interval described by a trading party and associated with a proposed trade of a financial interest proposed by the trading party has expired; and
the at least one computer determining a price for the proposed trade based on a description of a reference price and a description of a relationship between the reference price and the price for the proposed trade if the time interval has expired.

2. The method of claim 1, wherein the reference price description is provided by the trading party.

3. The method of claim 1, wherein the reference price description describes a type of price of the financial interest of the proposed trade.

4. The method of claim 1, wherein the reference price description describes a price related to one or more financial interests other than the financial interest of the proposed trade.

5. The method of claim 1, wherein the reference price description includes a description of a plurality of prices and one or more conditions such that the reference price description describes at least one of the plurality of prices if at least one of the one or more conditions is met and the reference price description describes at least one other of the plurality of prices if the at least one of the one or more conditions is not met.

6. The method of claim 1, wherein the description of the relationship between the reference price and the price for the proposed trade is provided by the trading party.

7. The method of claim 1, wherein the description of the relationship between the reference price and the price for the proposed trade includes a description of an offset between the reference price and the price for the proposed trade.

8. The method of claim 1, wherein the description of the relationship between the reference price and the price for the proposed trade includes a description of a limit on the price for the proposed trade.

9. The method of claim 1, wherein the description of the time interval includes a description of a specific length for the time interval.

10. The method of claim 1, wherein the description of the time interval includes a description of a random length for the time interval.

11. The method of claim 10, wherein the description of the random length includes a description of a minimum length.

12. The method of claim 10, wherein the description of the random length includes a description of a maximum length.

13. The method of claim 10, wherein the description of the random length includes a description of a factor of which the random length is a multiple.

14. A system for facilitating the trading of financial interests comprising at least one computer programmed to:
determine whether a time interval described by a trading party and associated with a proposed trade of a financial interest proposed by the trading party has expired; and
determine a price for the proposed trade based on a description of a reference price and a description of a relationship between the reference price and the price for the proposed trade if the time interval has expired.

15. A computer readable medium or media having programming stored thereon that when executed by at least one computer causes the at least one computer to:
determine whether a time interval described by a trading party and associated with a proposed trade of a financial interest proposed by the trading party has expired; and
determine a price for the proposed trade based on a description of a reference price and a description of a relationship between the reference price and the price for the proposed trade if the time interval has expired.

16. A method for facilitating the trading of financial interests, comprising:
at least one computer determining whether a time interval described by a trading party as having a random length and associated with a proposed trade of a financial interest proposed by the trading party has expired; and
the at least one computer determining a price for the proposed trade based on a description of a reference price and a description of a relationship between the reference price and the price for the proposed trade if the time interval has expired.

17. A system for facilitating the trading of financial interests comprising at least one computer programmed to:
determine whether a time interval described by a trading party as having a random length and associated with a proposed trade of a financial interest proposed by the trading party has expired; and
determine a price for the proposed trade based on a description of a reference price and a description of a relationship between the reference price and the price for the proposed trade if the time interval has expired.

18. A computer readable medium or media having programming stored thereon that when executed by at least one computer causes the at least one computer to:
determine whether a time interval described by a trading party as having a random length and associated with a proposed trade of a financial interest proposed by the trading party has expired; and
determine a price for the proposed trade based on a description of a reference price and a description of a relationship between the reference price and the price for the proposed trade if the time interval has expired.

19. A method for facilitating the trading of financial interests, comprising:
at least one computer determining whether a time interval described by a trading party and associated with a proposed trade of a financial interest proposed by the trading party has expired;
the at least one computer determining a price for the proposed trade based on a description of a reference price and a description of a relationship between the reference price and the price for the proposed trade if the time interval has expired; and
the at least one computer causing the proposed trade for which the price has been determined to be placed in a market where the proposed trade can be executed.

20. A system for facilitating the trading of financial interests comprising at least one computer programmed to:
determine whether a time interval described by a trading party as having a random length and associated with a proposed trade of a financial interest proposed by the trading party has expired;
determine a price for the proposed trade based on a description of a reference price and a description of a relationship between the reference price and the price for the proposed trade if the time interval has expired;
cause the proposed trade for which the price has been determined to be placed in a market where the proposed trade can be executed.

21. A computer readable medium or media having programming stored thereon that when executed by at least one computer causes the at least one computer to:
determine whether a time interval described by a trading party as having a random length and associated with a proposed trade of a financial interest proposed by the trading party has expired;
determine a price for the proposed trade based on a description of a reference price and a description of a relationship between the reference price and the price for the proposed trade if the time interval has expired; and
cause the proposed trade for which the price has been determined to be placed in a market where the proposed trade can be executed.

22. A method for facilitating the trading of financial interests, comprising:
at least one computer determining whether a time interval described by a trading party and associated with a proposed trade of a financial interest proposed by the trading party has expired; and
the at least one computer changing at least one term associated with the proposed trade if the time interval has expired.

23. The method of claim 22, wherein the at least one term includes a quantity.

24. The method of claim 22, wherein the at least one term includes a first quantity provided by the trading party and a second quantity representing a quantity for the proposed trade that is executable in a market; and
wherein the changing of at least one term comprises changing the second quantity to match the first quantity.

25. The method of claim 22, wherein the at least one term includes a price for the proposed trade.

26. The method of claim 25, wherein the changing of at least one term comprises changing the price for the proposed trade based on a description of a reference price and a description of a relationship between the reference price and the price for the proposed trade.

27. The method of claim 26, wherein the reference price description includes a description of a plurality of prices and one or more conditions such that the reference price description describes at least one of the plurality of prices if at least one of the one or more conditions is met and the reference price description describes at least one other of the plurality of prices if the at least one of the one or more conditions is not met.

28. The method of claim 26, wherein the at least one term includes a first quantity provided by the trading party and a second quantity representing a quantity for the proposed trade that is executable in a market; and
wherein the changing of at least one term comprises changing the second quantity to match the first quantity.

29. A system for facilitating the trading of financial interests comprising at least one computer programmed to:
determine whether a time interval described by a trading party and associated with a proposed trade of a financial interest proposed by the trading party has expired; and
change at least one term associated with the proposed trade if the time interval has expired.

30. A computer readable medium or media having programming stored thereon that when executed by at least one computer causes the at least one computer to:
determine whether a time interval described by a trading party and associated with a proposed trade of a financial interest proposed by the trading party has expired; and
change at least one term associated with the proposed trade if the time interval has expired.

31. A method for facilitating the trading of financial interests, comprising:
at least one computer determining whether a time interval described by a trading party as having a random length and associated with a proposed trade of a financial interest proposed by the trading party has expired; and
the at least one computer changing at least one term associated with the proposed trade if the time interval has expired.

32. A system for facilitating the trading of financial interests comprising at least one computer programmed to:
determine whether a time interval described by a trading party as having a random length and associated with a proposed trade of a financial interest proposed by the trading party has expired; and
change at least one term associated with the proposed trade if the time interval has expired.

33. A computer readable medium or media having programming stored thereon that when executed by at least one computer causes the at least one computer to:
determine whether a time interval described by a trading party as having a random length and associated with a proposed trade of a financial interest proposed by the trading party has expired; and
change at least one term associated with the proposed trade if the time interval has expired.
